(19) United States
(12) Patent Application Publication
(10) Pub. No.: US 2012/0204259 A1
(43) Pub. Date: Aug. 9, 2012

(54) BIOMETRIC AUTHENTICATION APPARATUS

(75) Inventor: Toshio Nakamura, Shiga (JP)

(73) Assignee: OKI ELECTRIC INDUSTRY CO., LTD., Tokyo (JP)

(21) Appl. No.: 13/503,363

(22) PCT Filed: Nov. 5, 2010
(86) PCT No.: PCT/JP2010/069744

§ 371 Date: Apr. 20, 2012

(30) Foreign Application Priority Data
Dec. 3, 2009 (JP) 2009-275683

(51) Int. Cl. H04L 9/32; G06F 21/00

(52) U.S. Cl. 726/19

(57) ABSTRACT

The present invention provides a biometric authentication apparatus capable of evaluating during operation with a scenario the same as during scenario evaluation. A layered structure is employed, with a BSP, a framework including an input-output section and a DB, and an application. The BSP includes a device control section that controls the device, a registration code generating section that generates a registered code from biometric data acquired by the device and stores the registered code in the DB, a matching code generating section that generates a matching code from the biometric data acquired by the device, and a one-to-one matching section that matches the matching code against a registered code read from the DB. The framework includes a registration section that performs registration processing by sending instructions to the device control section and the registration code generating section, and a matching section that performs matching processing by sending instructions to the device control section, the matching code generating section and the one-to-one matching section.

### TECHNICAL FIELD

The present invention relates to a biometric authentication apparatus.

### BACKGROUND ART

Biometric authentication is a technology for identifying an individual by employing biometric data, such as from fingerprints or irises. For performing biometric authentication in an apparatus, under ISO/IEC JTC1/SC37 standardization is progressing to a Biometric Application Programming Interface (BioAPI) as an interface between the biometric authentication technology part of the apparatus, for acquiring and matching biometric data, and the application.

Explanation follows regarding a biometric authentication apparatus employing BioAPI, with reference to FIG. 6. FIG. 6 is a schematic diagram of a biometric authentication apparatus employing BioAPI.

A biometric authentication apparatus 110 is, for example, configured with a component configured as software (software component) and a section configured as hardware (hardware component).

A device 120 for acquiring biometric data, such as a camera, is provided in the hardware component. The software component conforms to BioAPI, and is provided with a layered structure of a Biometric Service Provider (BSP) 140, a BioAPI Framework 160 and an application 180.

The BSP 140 is software positioned in a first layer, this being the lowest layer of the layered structure, and has a function for performing biometric data acquisition and matching, including a function for controlling the device 120. The BioAPI Framework 160 is software positioned in a second layer above the first layer and forms the core of the BioAPI. The application 180 is software positioned in the third layer above the second layer.

The interface between the BioAPI Framework 160 and the BSP 140 is called a Biometric Service Provider Interface (BioSPI). The BSP 140 provides a BioSPI function for the BioAPI Framework 160. The BioAPI Framework 160 accesses the BSP 140 by calling a BioSPI function.

The interface between the BioAPI Framework 160 and the application 180 is called BioAPI. The BioAPI Framework 160 provides a BioAPI function for the application 180. The application 180 accesses the BioAPI Framework 160 by calling a BioAPI function.

Usually BioSPI functions are present in one-to-one correspondence to BioAPI functions. Hence when the application 180 calls a BioAPI function, the BioAPI Framework 160 in turn calls the corresponding BioSPI function. For example, when performing biometric data registration, when the application 180 calls the BioAPI_Enroll function, the BioSPI_Enroll function is called and registration processing is performed. However, when performing matching, when the application 180 calls the BioAPI_Verify function, the BioSPI_Verify function is called and matching processing is performed.

Accuracy evaluation of registration processing and matching processing is performed using a failure-to-acquire rate (FTA), a failure-to-enrol rate (FTE), a false reject rate (FRR), and a false accept rate (FAR). Accuracy evaluation includes technology evaluation, scenario evaluation and operating evaluation (see, for example, “Information Technology—Biometric Performance Testing and Reporting—Part 1: Principles and Framework”, ISO/IEC 19795-1).

The technological evaluation employs sample data that has already been acquired, and evaluates the accuracy of such factors as FRR and FAR with an algorithm on its own.

In scenario evaluation, evaluation of such factors as FRR and FAR is performed in a biometric authentication apparatus employing a dummy application provided with a registration scenario and a matching scenario. In scenario evaluation, FRR and FAR evaluation is also performed of such aspects as the processing time for registration and authentication in the biometric authentication apparatus. In scenario evaluation, an evaluation of biometric data acquisition for a subject is also performed, and so an evaluation of ergonomics is also performed.

Operational evaluation is a similar evaluation to scenario evaluation, but performed during actual operation.

### DISCLOSURE OF INVENTION

### Technical Problem

However, the registration scenario and the matching scenario are provided in the application in the existing examples of biometric authentication apparatus described above. Since a dummy application is employed during scenario evaluation, sometimes there are differences to the application during operation. In such cases the scenario differs between scenario evaluation and operation evaluation, leading to the results of scenario evaluation not then being replicated during operation.

Since the evaluation items are also present in the application, it is difficult to achieve a complete match between scenario evaluation and operation evaluation.

In the present exemplary embodiment, since the scenarios for registration and matching are provided in the BioAPI framework, a biometric authentication apparatus is provided that is capable of evaluating with the same scenario during operation evaluation as during scenario evaluation.

### Solution to Problem

A first aspect of the present invention is a biometric authentication apparatus including a device for acquiring biometric data of a user and a control unit. The control unit has a Biometric Service Provider (BSP) positioned in the lowest layer, and a framework positioned in a layer above the BSP and including an input-output section and a database (DB), and an application positioned in a layer above the framework.

The BSP includes a device control section that controls the device, a registered code generating section that generates a registered code from biometric data acquired by the device and stores the registered code in the DB, a matching code generating section that generates a matching code from the biometric data acquired by the device, and a one-to-one matching section that matches the matching code against a registered code read from the DB. The framework includes a registration section that performs registration processing by sending instructions to the device control section and the registered code generating section, and a matching section that performs matching processing by sending instructions to the device control section, the matching code generating section and the one-to-one matching section. The application sends instructions to the registration section and the matching section.

### Advantageous Effects of Invention

According to the biometric authentication apparatus of the first aspect of the present invention, the scenario for registration and matching is provided as the registration section and the matching section in the framework. It is accordingly possible to evaluate according to the same standard since registration and matching are performed using the same scenario even when the application is different. The evaluation result items can also be easily unified for all BSPs. It is also possible to perform an accuracy evaluation progressively during actual operation.

Furthermore, since the DB and the input-output section such as a Graphical User Interface (GUI) are also provided in the framework, the development load for a BSP is reduced in comparison to a related system in which the input-output section is provided in the BSP.

Since the scenario for registration and matching is provided in the framework, the development load for an application can also be reduced in comparison to a related system in which the scenario is provided in an application.

### BRIEF DESCRIPTION OF DRAWINGS

FIG. 1 is a schematic diagram of a biometric authentication apparatus of a present exemplary embodiment.

FIG. 2 is an example of processing flow of a registration scenario.

FIG. 3 is an example of processing flow of a matching scenario.

FIG. 4 is an example of processing flow of fragmented all-item matching.

FIG. 5 is a schematic diagram illustrating a modified example of a biometric authentication apparatus of a present exemplary embodiment.

FIG. 6 is a schematic diagram of a biometric authentication apparatus in which BioAPI is employed.

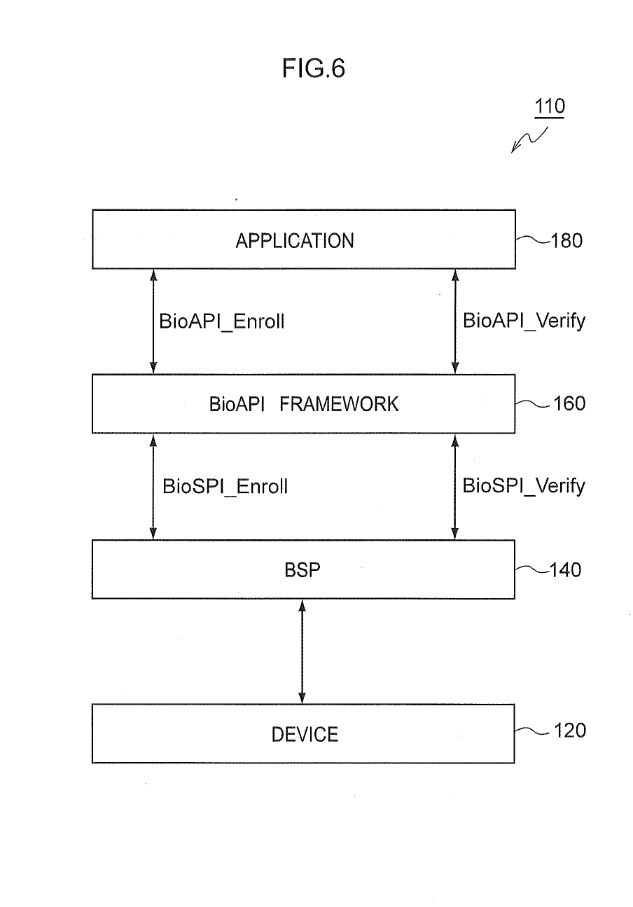

### BEST MODE FOR CARRYING OUT THE INVENTION

Explanation follows regarding an exemplary embodiment of the present invention with reference to the drawings. Note that the placement relationships between configuration elements are merely schematically represented at a level enabling understanding of the present invention. Explanation follows regarding a preferable configuration example of the present invention, however aspects such as numerical conditions are merely preferable examples thereof. The present invention is accordingly not limited by the following exemplary embodiments, and various changes and modifications can be implemented that can achieve the effect of the invention without departing from the scope of the configuration of the present invention.

### Biometric Authentication Apparatus

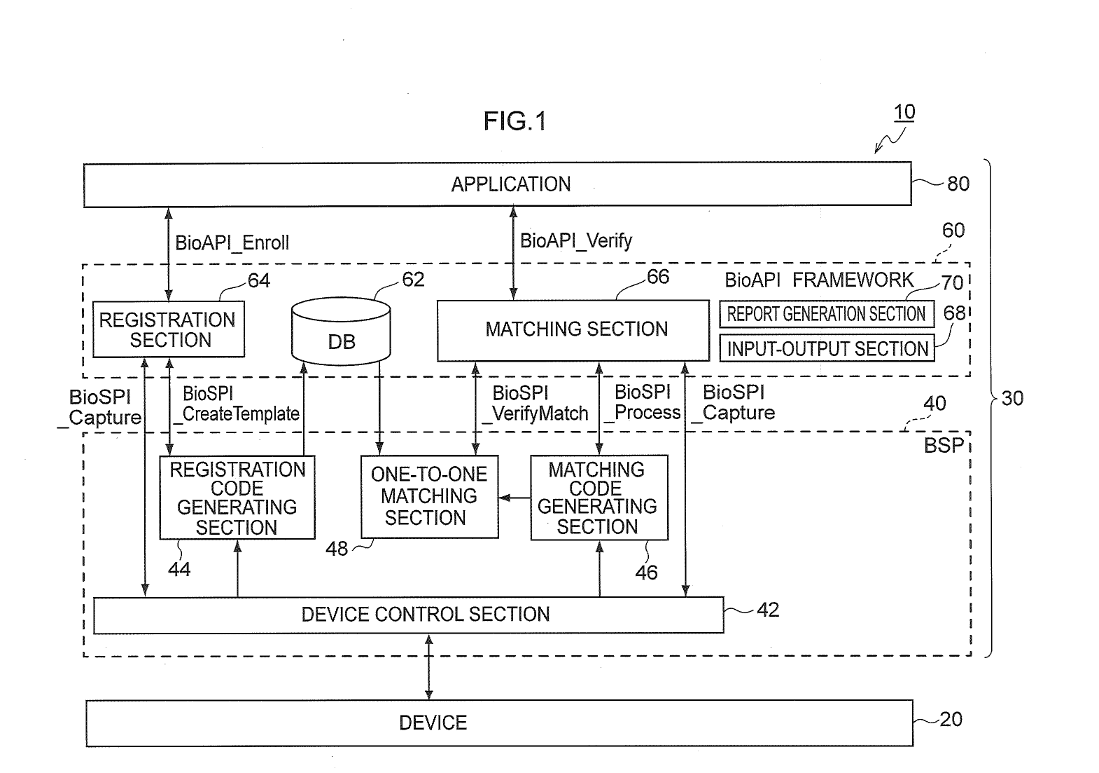

Explanation follows regarding a biometric authentication apparatus according to a first exemplary embodiment of the present invention, with reference to FIG. 1. FIG. 1 is a schematic diagram of a biometric authentication apparatus of the present exemplary embodiment.

A biometric authentication apparatus 10 is configured including a device 20 and a control unit 30.

The device 20 is employed to acquire biometric data of a user, and is configured including a camera, for example. When face recognition, vein pattern recognition, iris recognition or finger print recognition is performed for biometric authentication, an image is captured of the relevant region using a camera and biometric data acquired. In the following explanation acquired biometric data is sometimes referred to as acquired data. Note that while explanation follows regarding an example in which a camera is employed as the device 20, a device such as a microphone may be employed as the device 20 when voice pattern recognition is performed for biometric authentication.

The control unit 30 is configured by software with a layered structure.

There is a 3 layer structure in the layered structure specification of BioAPI, which is becoming the standard. A Biometric Service Provider (BSP) 40 is provided in the first layer, this being the lowest layer. A BioAPI framework 60 is provided as a framework in the second layer, this being the layer above the first layer. An application 80 is provided in a third layer, this being the layer above the second layer in which the BioAPI framework 60 is provided. Each of the functional components provided in the BSP 40, the BioAPI framework 60 and the application 80 are executed by an appropriate method, such as by execution of a specific program in a CPU (not shown in the drawings) provided in the biometric authentication apparatus.

The interface between the BioAPI framework 60 and the application 80 is called a Biometric Application Programming Interface (BioAPI). The application 80 accesses the BioAPI framework 60 by calling a BioAPI function.

The interface between the BioAPI framework 60 and the BSP 40 is called a Biometric Service Provider Interface (BioSPI). The BioAPI framework 60 accesses the BSP 40 by calling a BioSPI function.

The BSP 40 includes a function for acquiring and matching biometric data, including a function for controlling the device 20. The BSP 40 includes functional components of a device control section 42, a registered code generating section 44, a matching code generating section 46, and a one-to-one matching section 48.

The device control section 42 controls the corresponding device 20. The device control section 42 acquires biometric data of a user by, for example, causing a camera to operate and capture an image of a specific region. The BioAPI framework 60 actuates the device control section 42 when a BioSPI_Capture function is called as the BioSPI function.

The registered code generating section 44 generates a registered code (template) from biometric data received through the device control section 42. The registered code extracts a target region from photographic image data captured as biometric data, and also extracts features required for biometric authentication. The registered code is appended with data to identify a user, such as the user's name. The registered code generating section 44 registers the generated registered code in a database (DB) 62 provided in the BioAPI framework 60. The BioAPI framework 60 actuates the registration code generating section 44 when a BioSPI_CreateTemplate function is called as a BioSPI function.

The matching code generating section 46 generates a code for matching (matching code) from the biometric data received through the device control section 42. The matching code is a code in which a target region has been extracted from photographic image data captured as biometric data, and in which features required for biometric authentication have also been extracted. The BioAPI framework 60 actuates the matching code generating section 46 when a BioSPI_Process function is called as a BioSPI function.

The one-to-one matching section 48 matches the matching code generated by the matching code generating section 46 against one of the registered codes read from the DB 62. The one-to-one matching section 48 reads out the registered code of the user for matching from the DB 62. The one-to-one matching section 48 then compares the registered code and the matching code, and determines whether or not the registered code and the matching code contain the same features. The BioAPI framework 60 actuates the one-to-one matching section 48 when a BioSPI_VerifyMatch function is called as a BioSPI function.

The BioAPI framework 60 includes a registration section 64 and a matching section 66 in addition to the DB 62. Configuration may be made such that the BioAPI framework 60 is provided with a Graphical User Interface (GUI), for example, as an input-output section 68. When the biometric authentication apparatus 10 is provided with an output section, such as a display or speakers, and/or an input section, such as a keyboard or touch panel, the input-output section 68 controls the input section and the output section.

The input-output section 68 instructs a user to, for example, select which processing to perform out of registration or matching, and receives input from a user. The input-output section 68 also instructs a user to change the image capture subject. A change to the image capture subject is, for example, a change to the position of a finger or the finger used for finger print authentication, or a change to the direction of gaze or change to the right eye or the left eye in iris authentication.

The registration section 64 is a functional section for executing registration processing (registration scenario), and the registration section 64 performs registration processing by sending instructions to the device control section 42 and the registration code generating section 44. The application 80 starts registration processing by the registration section 64 when a BioAPI_Enroll function is called as the BioAPI function. The registration section 64 actuates the device control section 42 by calling a BioSPI_Capture function, and actuates the registration code generating section 44 by calling a BioSPI_CreateTemplate function.

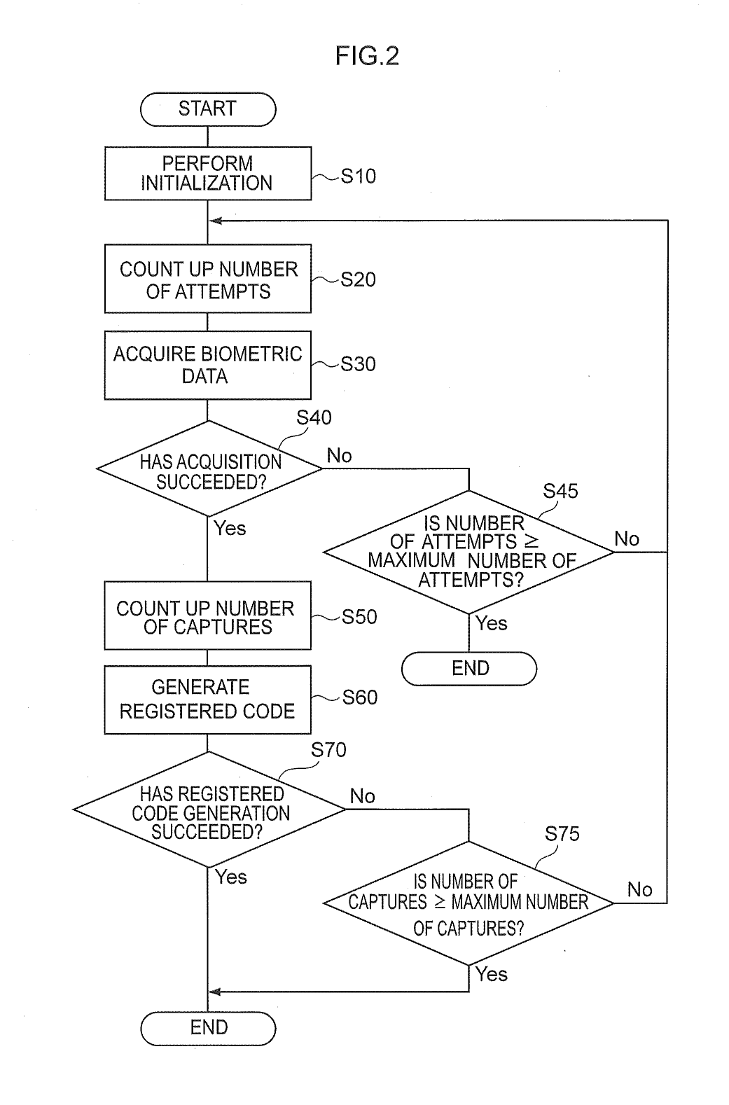

Explanation follows regarding an example of a registration scenario, with reference to FIG. 2. FIG. 2 is an example of a processing flow of a registration scenario. Explanation of processing related to the input-output section 68, such as a GUI, has been omitted.

The registration scenario is started by calling the BioAPI_Enroll function.

First variables are initialized at step (referred to below as S) 10. Variables of the number of attempts and the number of acquisitions (captures) are set to 0 by initialization.

Then the number of attempts is incremented at S20 by 1.

Then biometric data acquisition is performed at S30. Namely, the registration section 64 calls the BioSPI_Capture function.

Then at S40 determination is performed as to whether or not biometric data acquisition has succeeded. At S40 the device control section 42 of the BSP 40 extracts the target region from the acquired biometric data and determines whether or not biometric data is being acquired with a specific accuracy. The results of determination are sent to the BioAPI framework 60 as a BioSPI_Capture function execution result. When biometric data acquisition has succeeded according to the received acquired BioSPI_Capture function execution result, the registration section 64 continues on to perform S50. When biometric data acquisition has failed, the registration section 64 continues on to perform the processing of S45.

When the result determined at S40 is that biometric data acquisition has failed, the number of attempts is then compared in S45 with a predetermined maximum number of attempts. If the number of attempts is the maximum number of attempts or greater (Yes) then registration processing is ended. However, steps S20 to S40 are performed again when the number of attempts is fewer than the maximum number of attempts (No).

When the result determined at S40 is that biometric data acquisition has succeeded then the number of captures is incremented at S50 by 1.

Registration code generation is then performed at S60. Namely the registration section 64 calls the BioSPI_CreateTemplate function. In this process the registration code generating section 44 of the BSP 40 extracts features required for biometric authentication from the acquired biometric data and codes these features according to a specific format. Data of the user who is the registration subject is appended at this stage. The registered code generating section 44 stores the registered code in the DB 62. Configuration may be made such that user data is input by employing the input-output section 70 or by utilizing a section for identifying a user such as an ID card.

Then at S70 determination is performed as to whether or not registered code generation has succeeded. The result of whether or not feature extraction has succeeded is sent to the BioAPI framework 60 as the BioSPI_CreateTemplate function execution result. When registration code generation has succeeded according to the received execution result, the registration section 64 ends the registration processing, and continues on to perform processing of S75 when generation has failed.

When the result of determination at S70 is that biometric data acquisition has failed, then the number of captures is compared at S75 to a predetermined maximum number of captures. Registration processing is ended when the number of captures is the maximum number of captures or greater. However, the steps of S20 to S70 are performed again when the number of captures is fewer than the maximum number of captures.

The matching section 66 is a functional section for executing matching processing (matching scenario). The matching processing is performed by sending instructions to the device control section 42, the matching code generating section 46 and the one-to-one matching section 48. The matching section 66 performs matching processing when the application 80 has called the BioAPI_Verify function as the BioAPI function. The matching section 66 actuates the device control section 42 by calling the BioSPI_Capture function, actuates the matching code generating section 46 by calling the BioSPI_Process function, and actuates the one-to-one matching section 48 by calling the BioSPI_VerifyMatch function.

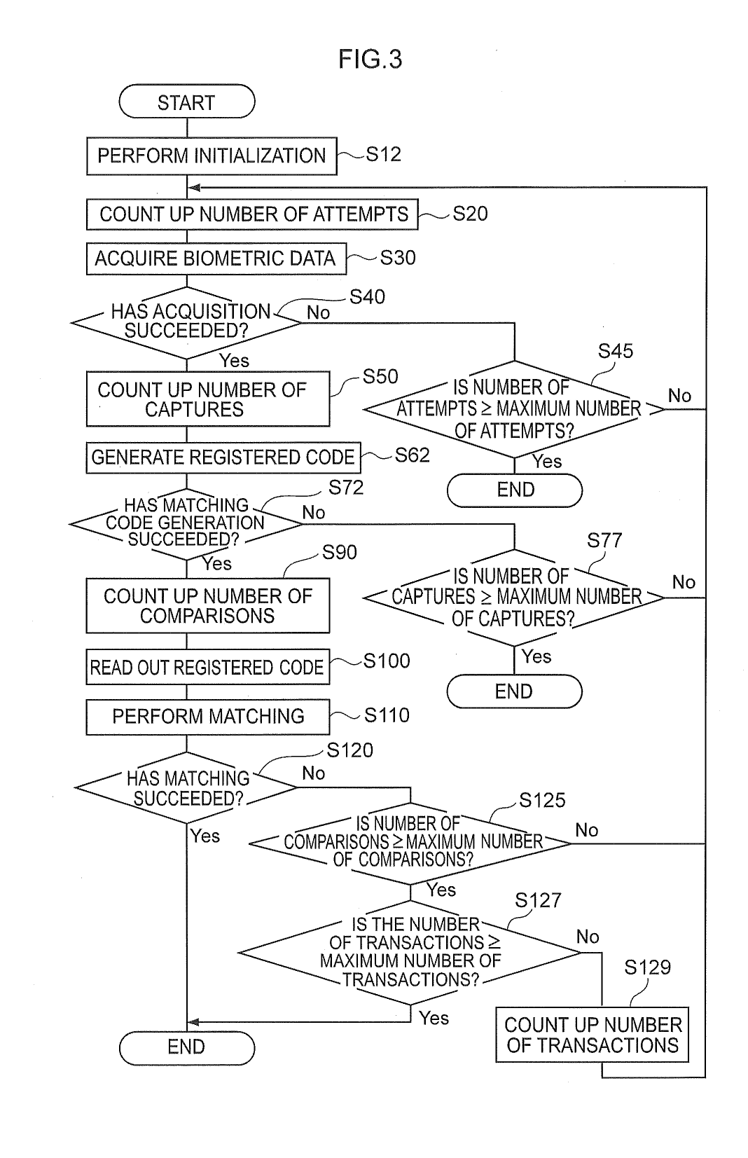

Explanation follows regarding an example of a matching scenario, with reference to FIG. 3. FIG. 3 is an example of a flow of processing of a matching scenario. Explanation regarding processing related to the input-output section 68, such as a GUI has been omitted.

The matching scenario is started by the BioAPI_Verify function being called.

Variables are first initialized at S12. Variables are the number of attempts, the number of captures and the number of comparisons, and these variables are set to 0 by initialization. The number of transactions is set at 1.

The processes of S20 to S50 are then performed. The processes from S20 to S50 are similar to those of the registration scenario and so further explanation thereof is omitted.

After incrementing the number of captures at S50 by 1, matching code generation is then performed at S62. In this process the matching section 66 calls a BioSPI_Process function.

Next at step S72 determination is performed as to whether or not matching code generation has succeeded. In this process the matching code generating section 46 of the BSP 40 extracts features required for biometric authentication from the acquired biometric data and codes the extracted features in a predetermined format.

The result of determination as to whether or not feature extraction has succeeded is sent to the BioAPI framework 60 as the BioSPI_Process function execution result. The matching section 66 continues to perform S90 when matching code generation has succeeded according to the received execution result. The matching section 66 continues to perform the processing of S77 when generation has failed.

When the result of determination at S72 is that the matching code generation has failed, then the number of captures is compared at S77 to a predetermined maximum number of captures. Matching processing is ended when the number of captures is the maximum number of captures or greater. However, steps S20 to S72 are performed again when the number of captures is fewer than the maximum number of captures.

When the result of determination at S72 is that biometric data acquisition has succeeded, the number of comparisons is then incremented at S90 by 1.

Then at S100, the registered code is read from the DB 62. The matching section 66 calls the BioSPI_VerifyMatch function in this process. The data of a user on which one-to-one matching is being performed is sent to the one-to-one matching section 48 as an argument of the BioSPI_VerifyMatch function. The one-to-one matching section 48 reads out a registered user code from the DB 62.

Then at S110 the one-to-one matching section 48 performs one-to-one matching comparison of the registered code read out from the DB 62 and the matching code.

Then determination is performed at S120 as to whether or not one-to-one matching has succeeded. This determination is performed by determining whether the degree of similarity between the registered code and the matching code is a specific threshold value or greater, or less than the threshold value. Determination is that there is a match of the registered code and the matching code when the degree of similarity is of the threshold value or greater. Namely, determination is made that ID authentication has succeeded using the one-to-one matching. However, determination is made that there is no match between the registered code and the matching code when the degree of similarity is less than the threshold value. Namely, determination is made that ID authentication using one-to-one matching has failed.

Note that while the ID authentication success rate increases by setting a small threshold value, the chance of another person being accepted by mistake also increases. Furthermore, when the threshold value is large, while the chance of another person being accepted by mistake is lower, the success rate of ID authentication is also lower. The threshold value is appropriately determined by a provider of the BSP 40 or by an administrator.

Processing is ended when matching processing is determined at S120 to have succeeded. However, when matching processing is determined to have failed, then the number of comparisons is compared at S125 against a predetermined maximum number of comparisons. When the number of comparisons is the maximum number of comparisons or greater (Yes) then the process of S127 is performed. However, when the number of comparisons is smaller than the maximum number of comparisons (No) then steps S20 to S120 are performed again.

At S127 the number of transactions is compared with a predetermined maximum number of transactions. When the number of transactions is the maximum number of transactions or greater matching processing is ended. However, processing of S129 is performed when the number of transactions is smaller than the maximum number of transactions.

The number of transactions is incremented by 1 at S129, and the number of attempts, the number of captures and the number of comparisons are set to 0. Steps S20 to S120 are then performed again.

In a matching scenario, when for example matching has not succeeded this time during steps S12 to S125, then there are cases in which this cycle of steps is permitted to be performed plural times. The number of such repetitions is referred to as the number of transactions. For example, when the maximum number of transactions is 3 then matching processing failure is permitted up to 2 times.

Note that while explanation has been given of an example in which the number of transactions is employed in the matching scenario, a number of transactions may also be employed in the registration scenario, as explained with reference to FIG. 2.

According to the biometric authentication apparatus 10 of the present exemplary embodiment, the registration section 64 and the matching section 66 for executing the registration scenario and the matching scenario are provided within the BioAPI framework 60. Hence, since registration and matching is performed with the same scenario even for applications 80 that are different from each other, evaluation according to the same standard is enabled. Furthermore, the evaluation result items for all BSP can be readily unified. Furthermore, since the same scenario is also employed during operation as is employed in the scenario evaluation, it is possible to perform an accuracy evaluation progressively in the operation environment, enabling evaluation that also gives reproducibility of scenario evaluation during operation.

Due to provision of the registration section 64 and the matching section 66 within the BioAPI framework 60, the development requirements for an application can be reduced in comparison to related systems in which the scenarios are provided in the applications.

The functions of the input-output section are same as those normally employed in biometric authentication. Accordingly, by providing the input-output section in the BioAPI framework the development requirements of a BSP can be reduced in comparison to a related system in which the input-output section is provided in the BSP.

The BioAPI framework 60 may also be provided with a report generation section 70 for generating reports showing the processing results of the registration section 64 and the matching section 66. The report items may, for example, be determined in accordance with ISO/IEC 19795.

In the present exemplary embodiment, the report generation section 70 is provided in the BioAPI framework 60, and so the scenario evaluation report items, namely the evaluation results, can be unified even in cases where there are plural systems subject to evaluation. In the present exemplary embodiment an evaluation result can be obtained with the same items as the scenario evaluation. Therefore continuous monitoring of such aspects as accuracy is facilitated by the present exemplary embodiment.

In the biometric authentication apparatus 10 of the present exemplary embodiment the DB 62 is provided in the BioAPI framework 60. In cases in which a DB is provided in the BSP, such as in a related biometric authentication apparatus, it is necessary to re-register all existing users if a new BSP is introduced. However in contrast thereto, with the biometric authentication apparatus of the present exemplary embodiment, the existing DB can be employed as it is when the BSP provided to an operating biometric authentication apparatus is changed over to a new BSP.

Explanation follows regarding the procedure for changing an existing BSP_A and device_A (technology A) over to a new BSP_B and device_B (technology B). Note that there is a compatible format of the registered code between the registered code A of the technology A and the registered code B of the technology B.

First the existing technology A is employed to select a subject from among the users who are registered in the DB 62, and to register the subject with the technology B. In such a case both the registered code A of the technology A and the registered code B of the technology B are stored in the DB 62. When matching is performed the technology B is employed for performing matching with both the registered code A and the registered code B.

From values of FAR and FRR for the registered code A and the registered code B employing the technology B an administrator can easily determine whether or not to prompt other user(s) to re-register. Matching can be performed with technology B for the registered codes in technology A for users who do not need to re-register. Accordingly, the biometric authentication apparatus of the present exemplary embodiment has excellent convertibility when technology A is changed to technology B in such aspects as the fact that re-registration is not required for all of the users.

Explanation has been given regarding an example of a matching scenario employing one-to-one matching, however a configuration enabled for one-to-many matching may be employed. In such cases a one-to-many matching section (not shown in the drawings) may be provided to the BSP 40.

The one-to-many section is for matching a matching code generated by the matching code generating section 46 against plural registered codes read from the DB 62. In such cases the one-to-many matching section reads out all the stored registered codes from the DB 62. The one-to-many matching section then matches the matching code against the plural registered codes, and determines whether or not the matching code matches one of the registered codes that have already been registered. The BioAPI framework 60 actuates the one-to-many matching section when a BioSPI_IdentifyMatch function is called as the BioSPI function.

Note that one-to-many matching can be executed even when the BSP 40 is not equipped with a one-to-many matching section, by utilizing a one-to-one matching section. In such cases data expressing plural registered codes is sent to the one-to-one matching section 48 as arguments to a BioSPI_VerifyMatch function. The one-to-one matching section 48 then reads out all of the registered codes from the DB 62 in sequence, and one-to-many matching is performed by repeatedly performing one-to-one matching thereon.

In order to obtain a false accept rate (FAR) for the accuracy of evaluation results during operation, all-item matching needs to be performed between the matching code and the registered codes within the DB, and a statistical analysis needs to be performed, such as on the degree of similarity when matching is performed with the codes of other people.

However, sometimes it takes time to perform one-to-many matching. A reason that one-to-many matching cannot be applied to a related biometric authentication apparatus is often due to the long time and heavy load on the CPU required to perform matching of all of the registered codes stored in the DB in order to perform biometric authentication of a user. However, the biometric authentication apparatus of the present exemplary embodiment makes it possible to perform fragmented all-item matching.

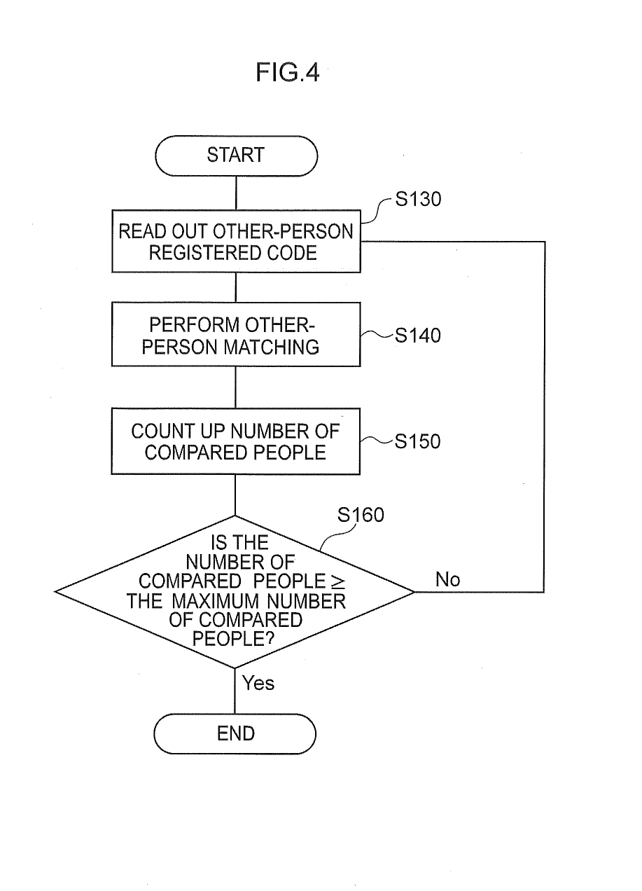

Explanation follows regarding fragmented all-item matching with reference to FIG. 4. FIG. 4 is an example of a processing flow of fragmented all-item matching. This fragmented all-item matching can be performed after success has been determined at the determination of S120 of the matching scenario explained with reference to FIG. 3.

After S120, the registered code of another person is then read out at S130. Namely, the one-to-one matching section 48 reads out the registered code of another user from the DB 62 (other-person registered code).

Then at S140 other-person matching is performed, namely one-to-one matching is performed between the other person's registered code and the matching code. After matching has been performed, a number of compared people is incremented at S150 by 1.

Then at S160, the number of compared people is compared to a maximum number of compared people. When the number of compared people is smaller than a maximum number of compared people then S130 is performed again. However, processing is ended when the number of compared people is the maximum number of compared people or greater.

For example, take a case in which the number of days to be employed for precise computation of fragmented all-item matching is denoted d, and the average number of uses performed by users in a day is denoted n, and the number of registered codes stored in the database is denoted e. In such a case, by setting such that matching is performed for e/(d×n) persons' worth of registered code as the maximum number of compared people per each time of use by a user, then an all-item matching will be completed in the number of days d.

For example, if the number of days d required for precise evaluation is 250 days, the number of times of use by users is n is 2 times on average, and the number of registered codes stored in the database DB e is 1000, then the maximum number of compared people a works out at 2 (=1000/(250×2)). In such cases since it is sufficient simply to add 2 other-person matches to each user match, the impact on the load on a CPU can be reduced.

In such cases, the registered code for other-person matching can be changed each time of matching by configuring such that, for example, the registered code of a user is appended as an index with data of the number of comparisons made therewith, and this number of comparisons is employed when acquiring other-person registered codes. Namely, it is possible to avoid repeatedly employing the same registered code.

Modified Example of Biometric Authentication Apparatus

In the above exemplary embodiment explanation has been given of cases in which the biometric authentication apparatus is configured as a single apparatus, however configuration may be made in which plural biometric authentication apparatuses are connected together through a network, such as the Internet.

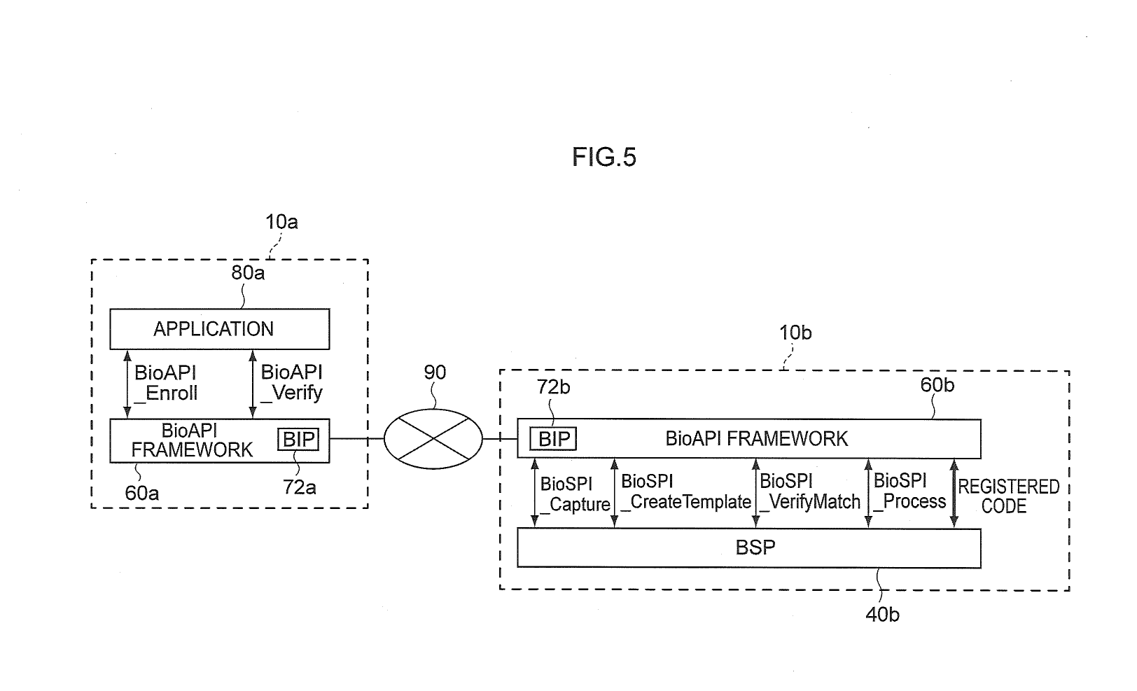

Explanation follows regarding an example in which a first biometric authentication apparatus and a second biometric authentication apparatus that are connected together through the Internet, with reference to FIG. 5. FIG. 5 is a schematic diagram illustrating a modified example of a biometric authentication apparatus of the present exemplary embodiment.

The first biometric authentication apparatus 10a is equipped with an application 80a and a BioAPI framework 60a. The second biometric authentication apparatus 10b is equipped with a BioAPI framework 60b and a BSP 40b. The BioAPI frameworks 60a and 60b provided to the first and the second biometric authentication apparatuses 10a and 10b include BioAPI Interworking Protocols (BIP) 72a and 72b. The BIP 72a and 72b have a function for converting BioAPI functions into network data, and for exchanging network data with other BIPs connected through a network.

For example, when the application 80a of the first biometric authentication apparatus 10a calls a BioAPI_Enroll function, the BIP 72a in the BioAPI framework 60a converts the data of the BioAPI function into network data and sends this data to the second biometric authentication apparatus 10b through the Internet 90.

The BioAPI framework 60b of the second biometric authentication apparatus 10b executes a registration scenario or a matching scenario according to instructions received from the first biometric authentication apparatus 10a. However, the execution result of the registration scenario or the matching scenario is sent to the BioAPI framework 60a of the first biometric authentication apparatus 10a over the Internet 90.

The BioAPI framework 60a sends the processing result received via the Internet 90 from the BioAPI framework 60b, namely the execution result of the registration scenario or matching scenario, to the application 80a. The application 80a acquires as an execution result of the BioAPI function for the BioAPI framework 60a the processing result according to the instruction imparted by calling the BioAPI. The application 80a is accordingly able to send an instruction to another biometric authentication apparatus and acquire the processing result of processing based on this instruction without being conscious of the presence of the Internet 90.

1. A biometric authentication apparatus comprising a device for acquiring biometric data of a user and a control unit comprising a Biometric Service Provider positioned in the lowest layer, and a framework positioned in a layer above the Biometric Service Provider and including an input-output section and a database, and an application positioned in a layer above the framework, wherein:
the Biometric Service Provider comprises
a device control section that controls the device,
a registration code generating section that generates a registered code from biometric data acquired by the device and stores the registered code in the database,
a matching code generating section that generates a matching code from the biometric data acquired by the device, and
a one-to-one matching section that matches the matching code against a registered code read from the database;
the framework comprises
a registration section that performs registration processing by sending instructions to the device control section and the registration code generating section, and
a matching section that performs matching processing by sending instructions to the device control section, the matching code generating section and the one-to-one matching section; and
the application sends instructions to the registration section and the matching section.

2. The biometric authentication apparatus of claim 1 wherein the framework further comprises a report generation section that generates a report based on a processing result of the registration section, the matching section or a combination thereof.

3. The biometric authentication apparatus of claim 1 wherein:
when performing the matching processing the matching section sends the matching code and an instruction to the one-to-one matching section to perform a one-to-one matching against the registered code of the user, and also sends to the one-to-one matching section the matching code and an instruction to perform a one-to-one matching against one or more registered codes of people other than the user.

4. The biometric authentication apparatus of claim 2 wherein:
when performing the matching processing the matching section sends the matching code and an instruction to the one-to-one matching section to perform a one-to-one matching against the registered code of the user, and also sends to the one-to-one matching section the matching code and an instruction to perform a one-to-one matching against one or more registered codes of people other than the user.

5. The biometric authentication apparatus of claim 1 wherein:
the Biometric Service Provider further comprises a one-to-many matching section that matches the matching code against a plurality of registered codes read from the database; and
the matching section further comprises a function that performs matching processing by sending instructions to the device control section, the matching code generating section and the one-to-many matching section.

6. The biometric authentication apparatus of claim 2 wherein:
the Biometric Service Provider further comprises a one-to-many matching section that matches the matching code against a plurality of registered codes read from the database; and
the matching section further comprises a function that performs matching processing by sending instructions to the device control section, the matching code generating section and the one-to-many matching section.

7. The biometric authentication apparatus of claim 3 wherein:
the Biometric Service Provider further comprises a one-to-many matching section that matches the matching code against a plurality of registered codes read from the database; and
the matching section further comprises a function that performs matching processing by sending instructions to the device control section, the matching code generating section and the one-to-many matching section.
